(19) United States
(12) Patent Application Publication
(10) Pub. No.: US 2025/0298669 A1
(43) Pub. Date: Sep. 25, 2025

(54) METHODS AND SYSTEMS FOR COMPUTATIONALLY EFFICIENT DATA OBJECT EXECUTION

(71) Applicant: Royal Bank of Canada, Toronto (CA)

(72) Inventors: Hisham ABU-ABED, Mississauga (CA); Akbar BUTT, Pickering (CA); Rex DAVIS, Minneapolis, MN (US); James X. GUO, Oakville (CA); Wei HUANG, Richmond Hill (CA); Kerry KHOO-FAZARI, Toronto (CA); Yu Shing LAW, Toronto (CA); Min LUO, Markham (CA); Priya RANGARAJAN, Guelph (CA); John WATT, Halifax (CA)

(21) Appl. No.: 19/089,929

(22) Filed: Mar. 25, 2025

Related U.S. Application Data
(60) Provisional application No. 63/569,411, filed on Mar. 25, 2024.

(51) Int. Cl. G06F 9/50; G06N 5/04

(52) U.S. Cl. CPC G06F 9/5038; G06N 5/04

(57) ABSTRACT

Methods and systems for data management optimization are disclosed. The methods involve retrieving at least one of data querying instructions or data generating paths, and constructing knowledge graphs to visualize data structure within the data objects. Data objects are matched to determine similarities among the knowledge graphs. Cost functions determined by the similarities generate costs to evaluate aspects of the data objects, which are then ranked to inform data processing workflows within the data management system. This disclosure improves data handling efficiency and operational performance.

### CROSS-REFERENCE TO RELATED APPLICATIONS

The present disclosure claims priority to and benefit of U.S. provisional application No. 63/569,411, filed Mar. 25, 2024 and entitled “METHODS AND SYSTEMS FOR DATA MANAGEMENT OPTIMIZATION”, the entirety of which is hereby incorporated by reference herein.

### TECHNICAL FIELD

The present disclosure is directed to data management systems, and more particularly to methods and systems for retrieving and executing data objects stored in a data lake or database in a computationally efficient manner.

### BACKGROUND

Data management systems are essential for storing, retrieving, and manipulating large volumes of information across multiple domains. At the core of these systems are data querying instructions, which are commands or sets of commands used to interact with databases. These instructions allow users to specify the exact data operations they intend to perform, such as data retrieval, insertion, update, and deletion. Such instructions offer a robust and flexible syntax for defining and manipulating data.

Data retrieval through data querying instructions involves specifying criteria that the retrieved data should meet. For example, a data querying instruction can request data from a specific table within a database that matches certain conditions, joins data from multiple tables based on relational keys, or aggregates data to provide summaries like counts, averages, or totals. These operations rely on the underlying database management system to parse the query, perform the specified operations, and return the requested data to the user. The efficiency and effectiveness of these data querying instructions may affect the performance of the data management system, especially in environments characterized by large, complex datasets.

### SUMMARY

According to a first aspect, there is provided a method, comprising: a) retrieving, from a database, input that includes a plurality of data objects comprising at least one of data querying instructions or data generating paths; b) constructing a plurality of knowledge graphs using relationships among data elements in the plurality of data objects; c) matching the data elements of the plurality of knowledge graphs in a mathematical space to determine similarities among the plurality of knowledge graphs; d) generating a cost score for at least some of the plurality of data objects using a cost, wherein the cost is generated by applying at least one cost function for evaluating the plurality of data objects, and wherein the at least one cost function is determined using the similarities; e) ranking the at least some of the plurality of data objects by their cost scores; and f) outputting the data object in response to the corresponding cost score being ranked higher than a threshold.

In some embodiments, the at least one cost function may comprise a structure cost function that yields the costs of the plurality of data objects according to similarities among data structures of the plurality of data objects.

In some embodiments, the at least one cost function may comprise an operation cost function that yields the costs of the plurality of data objects according to efficiencies among data operations of the plurality of data objects.

In some embodiments, the at least one cost function may comprise an element cost function that yields the costs of the plurality of data objects according to significances among the data elements.

In some embodiments, the method may further comprise preprocessing the received input, and the preprocessing may comprise at least one of cleaning, normalizing, or standardizing.

In some embodiments, the relationships among the data elements may comprise at least one of relational algebraic operations or data flow paths.

In some embodiments, the method may further comprise embedding the plurality of knowledge graphs into a lower-dimensional mathematical space by preserving algebraic properties to facilitate similarity-based matching of the data objects.

In some embodiments, the mathematical space may be a vector space.

In some embodiments, the data querying instructions may comprise Structured Query Language (SQL) statements.

In some embodiments, the at least one cost function may preserve a partial order for comparing the data objects.

In some embodiments, each of the costs may be represented by positive real numbers.

In some embodiments, the at least one cost function may comprise a structure cost function that yields the costs of the plurality of data objects according to similarities among data structures of the plurality of data objects; the at least one cost function may comprise an operation cost function that yields the costs of the plurality of data objects according to efficiencies among data operations of the plurality of data objects; the at least one cost function may comprise an element cost function that yields the costs of the plurality of data objects according to significances among the data elements; and the generating may comprise aggregating at least two of the structure cost, the operation cost, or the element cost, each cost being assigned a corresponding weight.

In some embodiments, the weight may be assigned using empirical data derived from a training set, or is learned from users' inputs or the plurality of knowledge graphs.

In some embodiments, the method may further comprise in response to one of the cost scores not satisfying a predetermined condition, returning to b).

In some embodiments, the method may further comprise applying the ranking of the at least some of the plurality of data objects to optimize data processing workflows in a data management system, wherein the optimization includes selecting a data querying instruction or data generating path for a data processing task based on the ranked cost scores.

According to a second aspect, there is provided a data object execution method, comprising: a) retrieving, from a data lake, input that includes a plurality of data objects; b) constructing a plurality of knowledge graphs using relationships in the plurality of data objects; c) matching the plurality of knowledge graphs in a mathematical space to determine similarities among the plurality of knowledge graphs; d) generating a plurality of cost scores for the plurality of data objects, the cost scores generated by applying one or more cost functions for evaluating the plurality of data objects, and at least one of the one or more cost functions determined using the similarities; e) ranking the at least some of the plurality of data objects based on the plurality of cost scores; and f) executing at least one of the plurality of data objects based on the ranking.

In some embodiments, the plurality of data objects comprises: one or more data querying instructions, one or more data generating paths, one or more data flow paths, or combinations thereof.

In some embodiments, the one or more data querying instructions comprise Structured Query Language (SQL) statements.

In some embodiments, the method may further comprise: receiving metadata and/or log data associated with the plurality of data objects for the constructing of the knowledge graphs and for determining the similarities.

In some embodiments, the one or more cost functions comprise a structure cost function that yields data structure costs of the plurality of data objects; and the data structure costs are determined based on the similarities.

In some embodiments, the one or more cost functions comprise an operation cost function that yields operation costs of the plurality of data; and the operation costs correspond to costs of performing operations defined by the plurality of data objects.

In some embodiments, the one or more cost functions comprise an element cost function that yields data element costs of the plurality of data objects; and the data element costs are determined based on a significance and/or security standard of the plurality of data objects.

In some embodiments, the method may further comprise: generating the one or more cost functions based on the meta data, the log data, the plurality of data objects, or combinations thereof.

In some embodiments, the one or more cost functions preserve a partial order of data structures of the plurality of data objects corresponding to amounts of information yielded by the plurality of data objects.

In some embodiments, each of the plurality of cost scores is calculated as a sum of costs yielded by the one or more cost function; a weight is assigned to each cost yielded by the one or more cost functions; and the weight is determined using empirical data derived from a training set, or is learned from users' inputs or the plurality of knowledge graphs.

In some embodiments, the method may further comprise: preprocessing the plurality of data objects, and wherein the preprocessing comprises at least one of cleaning, normalizing, or standardizing.

In some embodiments, the constructing comprises: translating each of the plurality of data objects into a relational algebra expression; a node in each of the plurality of knowledge graphs corresponds to a data element or a relational algebraic operations; and an edge in each of the plurality of knowledge graphs corresponds to a relationship between data elements.

In some embodiments, the matching comprises: embedding the plurality of knowledge graphs into a lower-dimensional vector space.

In some embodiments, the embedding preserves algebraic properties of the plurality of data objects comprising associativity and/or idempotence.

In some embodiments, the similarities are determined using exact matching or best possible matching.

In some embodiments, the plurality of cost scores are represented by positive real numbers.

In some embodiments, the method may further comprise: validating the plurality of cost scores and in response to one of the cost scores not satisfying a predetermined condition based on the validating, returning to b).

In some embodiments, the method may further comprise: applying the ranking to optimize data processing workflows in a data management system, wherein the applying comprises selecting at least one data object for a data processing task based on ranked cost scores.

According to a third aspect, there is provided a non-transitory computer readable medium having stored thereon computer program code that is executable by at least one processor and that, when executed by the at least one processor, causes the at least one processor to perform the method of any of the above aspects.

According to a fourth aspect, there is provided a system comprising at least one processor configured to perform the method of any of the above aspects.

According to a fifth aspect, there is provided a system, comprising: a memory for storing instructions; a database stored in the memory, the database containing a plurality of data objects comprising at least one of data querying instructions or data generating paths; a processor communicatively coupled to the memory and the database, the processor configured to: a) retrieve input from the database that includes the plurality of data objects; b) construct the plurality of knowledge graphs using the relationships among the data elements in the plurality of data objects; c) match the data elements of the plurality of knowledge graphs in a mathematical space to determine similarities among the plurality of knowledge graphs; d) generate a cost score for at least some of the plurality of data objects using a cost, wherein the cost is generated by applying at least one cost function for evaluating the plurality of data objects, and wherein the at least one cost function is determined using the similarities; e) rank the at least some of the plurality of data objects by their cost scores; and f) output the data object in response to the corresponding cost score being ranked higher than a threshold; and a communication interface for receiving the input and sending the output.

This summary does not necessarily describe the full scope of all aspects. Other aspects, features and advantages will become apparent to those of ordinary skill in the art upon review of the following description of specific embodiments.

### BRIEF DESCRIPTION OF THE DRAWINGS

In the accompanying drawings, which illustrate one or more example embodiments:

FIG. 1 depicts a knowledge graph corresponding to a relational database operation as prescribed by an SQL statement, according to an example embodiment.

FIG. 2 depicts two data generating paths used to construct the knowledge graph of FIG. 1.

FIG. 3 depicts a merge operation for knowledge graphs, according to an example embodiment.

FIG. 4 depicts a composition operation for knowledge graphs, according to an example embodiment.

FIG. 5 depicts a merge operation for data generating paths, according to an example embodiment.

FIG. 6 depicts a composition operation for data generating paths, according to an example embodiment.

FIG. 7A depicts a flow chart for processing and analyzing data objects which include at least one data querying instructions or data generating paths within a data management system, according to an example embodiment.

FIG. 7B depicts a method for processing data objects, according to an example embodiment.

FIG. 8 depicts an example computer system that may be used to implement the method for data management, according to an example embodiment.

FIG. 9 depicts a system for processing data objects, according to an example embodiment.

### DETAILED DESCRIPTION

Many of today's applications, such as artificial intelligence (AI), rely on large and complex data sets, often referred to as “big data”. This data is characterized not only by its sheer volume, but also by its variety of formats and the rapid pace at which it changes. Addressing the challenges posed by these dynamic data landscapes involves navigating the intricacies of data generation and storage across a variety of platforms, ensuring seamless integration of disparate data sources while preserving their intrinsic relationships, maintaining high data quality amid potential noise, and adapting machine learning models to continuously evolving data.

The foundation of machine learning models is the trustworthiness and quality of the data on which they are trained. To ensure data quality, it is important to have a thorough understanding of the lineage or provenance of the data. This includes knowledge of the origins, methods of generation, and interactions between data elements. An effective approach to representing these interactions is the use of knowledge graphs, which visually depict the connections and pathways between data elements.

In a data lake environment, where data from numerous sources is aggregated, the interaction with data encompasses a wide range of activities. Data elements are generated and transformed through various paths, which include executing a series of data querying instructions encompassing diverse operations. These operations not only retrieve and manipulate data but also contribute to the generation of new data elements. The resulting data elements are subsequently organized and stored in different segments of the data lake's infrastructure. Given the complexity of these processes, it may be useful to evaluate the efficiency of the data querying instructions and the entire data generating paths. Such an assessment may identify potential risks, optimize data flow, and maintain the integrity of the data within the lake. A data lake may comprise one or more databases.

In particular, data can be sourced from multiple silos with different formats and constant changes. As such, data management, access, and generation can be technically challenging as data: (1) can be generated by many ways and stored in multiple dynamic platforms; (2) may need to be integrated together with the existing relationships being preserved; (3) can be noisy and preferably is of high quality to be consumed; (4) may be provided to machine learning models for processing, which may need to be robust enough to capture dynamic data changes; and (5) can affect machine learning drivers and features which can be correlated and can also have their dependencies. Specifically, the derivation of reliable data for machine learning is a challenge that can be overcome by means of the present disclosure, which relates to the processing of data objects.

This disclosure outlines a comprehensive set of methods for systematically comparing and ranking data querying instructions and the paths they generate, and executing corresponding data objects. This analysis may be based on criteria that evaluate the effectiveness, efficiency, and reliability of each data manipulation method. By examining a selected set of data elements, data querying instructions, and their generating paths within the database, this disclosure seeks to highlight efficient strategies for data generation and manipulation, thereby improving data management systems. As disclosed herein, the present disclosure can provide methods for dealing with data challenges and data management, such as by comparing and ranking data generating paths, dynamic data lineages, data entity resolution, and data knowledge graphs.

In at least some embodiments, the disclosed methods can: (1) improve data quality and manage data risks more accurately using dynamic optimal data generating paths; (2) allow tracking and managing of data more efficiently by understanding the generating paths of data elements; (3) integrate data with the existing relationships from the platforms being preserved; and (4) better utilize data and make systematic decisions using data knowledge/insights (e.g. knowledge graphs) on top of the data, using the ontology of data generating paths and their comparisons.

SQL (Structured Query Language) is a programming language designed for managing and manipulating relational databases. It enables a range of operations, including data querying, database updates, and schema management. While SQL statements are utilized herein as illustrative examples to convey the application of the proposed methods, it is important to note that the scope of this disclosure is not confined to SQL. It extends to a broad spectrum of data querying instructions, potentially including but not limited to, NoSQL query languages, graph query languages such as Cypher™, or specialized languages developed for specific data analytics frameworks.

In one embodiment, an example system improves the management and optimization of data within databases using algebraic data structures and knowledge graph technologies. This system systematically analyzes data querying instructions and data generating paths that facilitate data manipulation and generation across different platforms and environments. The complex data relationships and operations through the constructs of knowledge graphs, which when combined with the principles of algebraic data structures, provide a powerful means to evaluate, compare, and optimize data processes. To compare and rank data objects algebraically, the disclosed methods can utilize knowledge graph technologies to build dynamic data lineages. Although data lineages and generating paths, based on meta data, log files, and SQL statements are static, the present disclosure describes systematically comparing and ranking data objects to achieve data robustness. Further, polynomials over semirings and Datalog™ (e.g. a subset of Prolog™) can provide some dynamic data provenances.

Data querying instructions, which serve as one of the inputs to the system, encompass a range of commands or sets of commands that are executed to retrieve data from a database. These instructions are integral to the functioning of data management systems, facilitating operations such as data retrieval, insertion, deletion, and updating. Data generating paths constitute another input, representing the sequences of operations or procedures through which data is produced, modified, or organized. These paths are related to the lifecycle of data elements within the system, from their inception to their eventual storage or utilization. By examining these generating paths, the system can identify potential inefficiencies or bottlenecks in data processing workflows, offering opportunities for refinement and optimization. The data querying instructions and the data generating paths can be collectively referred to as data objects.

While metadata and log files may be considered optional data objects, they contribute to the depth and accuracy of the analysis. Metadata provides contextual information about the data, including details about data structures, relationships, constraints, and types, enriching the knowledge graph representations and allowing for more nuanced analyses. Log files, on the other hand, record transactional or operational events within the database, offering empirical data that can be used to assess the performance of data querying instructions and generating paths in real-world scenarios.

Note that it can be difficult to compare and rank data objects such as SQL statements and data generating paths due to the uncertainty and complexity. Further, metadata, log files, and SQL statements are important for generating data lineages but may be stored separately and partially, in multiple platforms. As such, there are potential risks with sourcing data from suboptimal data repositories. Therefore, the present disclosure can improve data quality and manage data risks systemically by processing data objects (e.g. data querying instructions and data generating paths), the data objects can be compared and evaluated based on factors such as efficiency and security. Accordingly, the most suitable data objects can be implemented based on the processing results. Specifically, the present disclosure can provide unified methods for addressing data quality and risks by comparing and ranking data objects such as data generating paths and SQL statements to improve data efficiencies and can analyze dynamic data lineages without complete reliance on metadata, log files, and SQL statements. The disclosed methods can also be implemented using generic data integration tools that can preserve existing data relationships.

Consider the origin of a piece of data (e.g. a data element) and the relationship between source data and result data. This information provides data lineage or provenance: where, how, and even why the data element is generated, which can be represented by knowledge graphs. Generating data elements in a data lake can involve extensive human interaction with data where the data element may be generated by multiple ways or generating paths. For instance, data scientists may generate a data set with different pieces of SQL statements, which are stored in different folders (e.g. different locations in the database or different databases) in the data lake. To assess the efficiencies of the SQL statements and to track potential data risks, it is possible to compare and rank the ways to determine the optimal way for generating the data, based on certain criteria. Accordingly, the present disclosure provides methods which can be used for comparing and ranking data objects such as SQL statements and the generating paths of each data element in one or more data lakes. In particular, the methods may compare a set of data elements in a data lake such as a data folder, repository, or database.

There are various technical benefits that can be derived from the disclosed methods. In particular, computational efficiency for platforms and services utilizing data objects can be improved. As multiple different data objects can perform the same function or similar functions, it can be beneficial to evaluate and compare the data objects such that a suitable (e.g. more computationally efficient) data object is executed. However, such an evaluation and comparison can be challenging due to the complexity of the data objects as well as other confounding/auxiliary factors. Nevertheless, the disclosed methods can compare, evaluate, and rank the data objects according to cost scores. The cost scores can be determined based on various criteria that includes or affects computational efficiency of (executing) the data object such as data structure, similarities, and partial order relative to one another. Accordingly, the ranking of the data objects can reflect the computational efficiencies of the data objects in terms of resource cost, execution time, etc. As such, it is possible to execute the more computationally efficient data object(s) according to the ranking (e.g. executing the highest ranked data object), thus improving computational efficiency as compared to the execution of the data objects normally (e.g. execution of the lower ranked data objects in standard operation). In particular, when faced with a specific task (e.g. data generation/retrieval) executable by a plurality of data objects, it is possible to perform the disclosed methods as to determine a data object that is more computationally efficient in executing the task. Further, if the plurality of data objects are implemented as a part of a platform or service, it is possible to replace all instances of the data objects with the more computationally efficient data object as determined by the disclosed methods, thus improving the overall efficiency of the platform or service (e.g. future instances of performing the specific task). The disclosed methods can also enhance data security. In particular, the security of data objects can be a factor in determining the cost scores. For example, when retrieving or generating a data element, the different data objects may specify the retrieval of the data element from various repositories having different security standards (e.g. more/less secured databases), route the data element in different manners, or process the data element differently in ways that will enhance/degrade the security of the data element. As a portion of the disclosed methods, the ranking of the data objects (e.g. from the cost scores) can be affected by the security of the data object (which impacts the cost scores). Thus, execution of the data objects according to the ranking can result in more secure data operations. Further, it is possible to replace all instances of a plurality of evaluated data objects in a platform or service with the more secure data object to enhance data security in the platform or service.

As used herein, a data object can comprise a data querying instruction, a data generating path, a data flow path, etc. A data querying instruction can refer to statements, paths, or instructions for retrieving one or more data elements (e.g. from a dataset) and a data generating path can refer to statements, paths, or instructions for generating one or more data elements. A data element can be a single piece of or a collection of data such as one or more datasets (e.g. tables) or portions thereof (e.g. columns/fields in the tables).

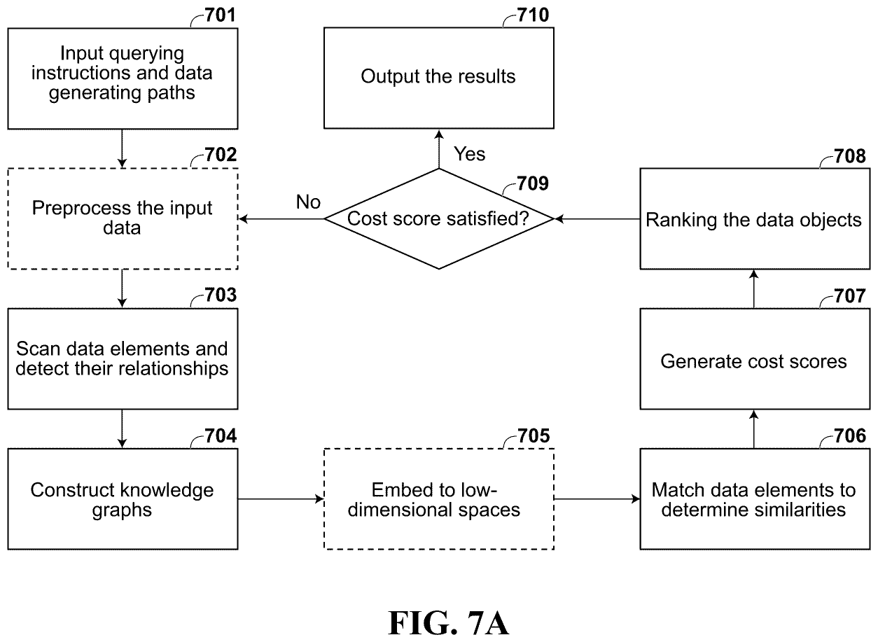

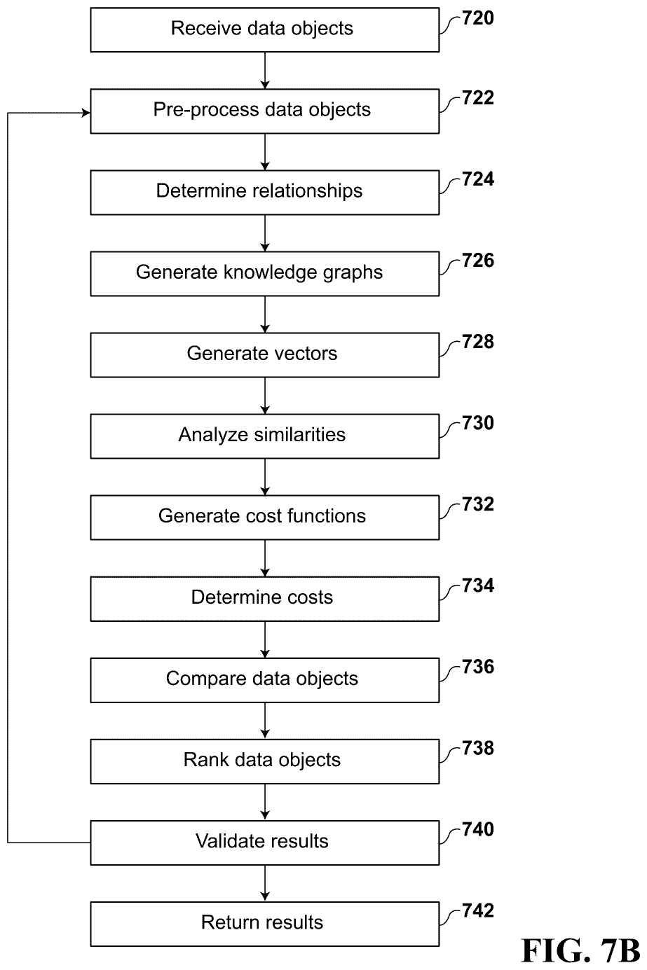

Referring first to FIG. 7B, a method for processing data objects is depicted. At 720, data objects are received (e.g. from a user) or retrieved (e.g. from a device) for processing. Additional data associated with the data objects such as metadata and log files can also be received or retrieved. As an example, the data objects can be retrieved or extracted from data lakes comprising, for example, databases. As another example, one or more data elements may first be identified. Subsequently, the data objects corresponding to (e.g. instructions/paths for querying/generating the data elements) can be determined or extracted. It should be noted that the data objects may serve the same or similar purposes, for example used to retrieve/generate the same or similar data elements. Accordingly, the data object processing method can compare the data objects based on the efficiency/security thereof. At 722, the received or retrieved data can be preprocessed by cleaning, normalizing, and standardizing the data.

### Knowledge Graph

At 724, the data objects can be analyzed to identify the elements comprised therein as well as determine the relationship of the elements. These relationships can be used to generate the knowledge graphs at 726. A knowledge graph can be generated for each of the processed data objects. The received metadata and log files can provide contextual information about the data objects, including details about data structures, relationships, constraints, and types. The additional contextual information can be used in the generation of knowledge graphs.

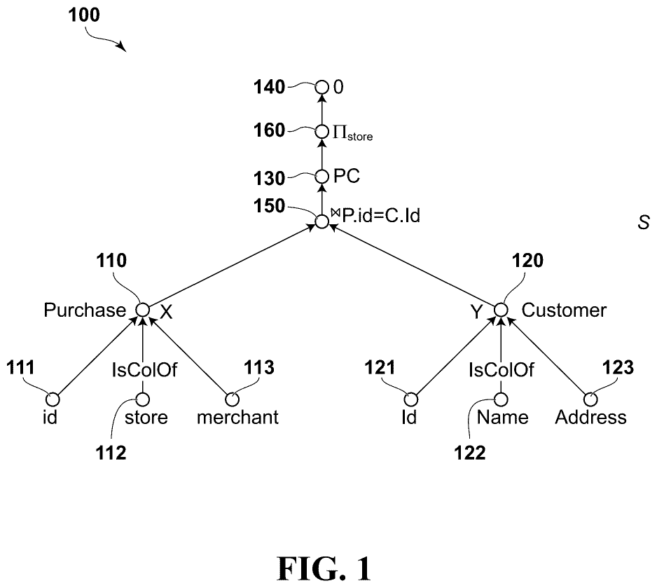

FIG. 1 illustrates an example knowledge graph 100 corresponding to a relational database operation as prescribed by an SQL statement (e.g. data querying instruction), according to an embodiment described herein. The knowledge graph 100 provides a structural overview of the data elements, their attributes, and the relational algebraic operations that facilitate the interaction between these data elements within a database environment. A node in a knowledge graph can be a data element or relational algebraic operation (e.g. an element) comprised in a data object. Correspondingly, an edge in a knowledge graph can be a relationship between two elements (e.g. data element or relational algebraic operation). These elements and relationships can be extracted or identified at 724.

Nodes within the knowledge graph 100 are classified based on their roles and relationships. Primary nodes 110 (labeled “X”) and 120 (labeled “Y”) represent the “Purchase” and “Customer” data sets, respectively, indicating the origin of data within the database tables involved in the SQL operation. An additional primary node 140 (labeled “O”) denotes the output resulting from the relational query, which is the focal point of the data retrieval process. In some embodiments, the knowledge graphs can comprise layers which correspond to the data objects.

An intermediate primary node 130 (labeled “PC”) signifies a processing checkpoint that emerges from the join operation between the “Purchase” and “Customer” datasets (e.g. tables) at the nodes 110, 120. The node 130 facilitates the creation of the final output “O” and represents a merged view of the data satisfying the join condition.

Starting nodes, such as 111 (labeled “id”), 112 (labeled “store”), and 113 (labeled “merchant”) for the “Purchase” node 110 in the table as well as 121 (labeled “Id”), 122 (labeled “Name”), and 123 (labeled “Address”) for the “Customer” node 120 in the table, symbolize columns of data elements. These starting nodes are used for defining the structure of the data sets and pinpointing specific columns that are leveraged during the SQL operation.

Directed edges with arrows depict the flow and transformation of data across the knowledge graph 100. These directed edges are not merely connections but encapsulate the application of specific relational algebra operations such as joins and selections. For instance, an edge leading from the “Purchase” node 110 to the “PC” node 130 is joined with another edge leading from the “Customer” node 120 to the “PC” node 130, based on matching identity elements.

Further enriched with conditions, some edges also portray the criteria underpinning these operations. The “ [symbol] .id=C.Id” along the edge denotes a joining operation 150 (indicated by “S” to the right) with the condition P.id=C.Id, where records from the “Purchase” and “Customer” nodes 110, 120 are matched based on their respective “id” and “Id” elements. The joining operation is a database query process that merges rows from two or more tables based on a related column between them, in this case, “id” and “Id”. “Πstore” on the edge leading to the “O” node 140 represents a selection operation 160 of the “store” column or attribute from the resultant data set. The selection operation is a database query process that selects columns from a table, effectively reducing the number of columns in the resultant dataset.

In FIG. 1, each of nodes 110, 111, 112, 113, 120, 121, 122, 123, 130, and 140 corresponds to a data element and the nodes 150 and 160 correspond to relationship algebraic operations. In FIG. 1, each edge can represent a relationship between two data elements and/or operations (e.g. nodes). For example, the edge between the “Purchase” node 110 and the “store” node 112 indicates that the store data element comprising information of a particular store can be retrieved from the “Purchase” dataset.

The edges within the knowledge graph can be either directed or undirected, indicating the nature of the relationships among data elements. Directed edges illustrate unidirectional relationships where data flows from one element to another, such as when one data element is a subset of another data element. Conversely, undirected edges represent bidirectional or non-directional relationships, indicating shared characteristics between data elements without implying a specific direction of data flow or operation, such as when data elements share common columns.

### Data Querying Instructions and Data Generating Paths

The generation of a knowledge graph makes use of data querying instructions or data generating paths. One example of the data querying instructions according to the embodiments described herein is SQL statements. An example of the SQL statement code:

“SELECT P.store
FROM Purchase P, Customer C
WHERE P.id = C.Id
AND C.city = ‘Toronto’”

may be visualized in the knowledge graph 100 as an execution path that begins with the “Purchase” and “Customer” nodes, filters through the selection criteria, joins on the common identifier, and concludes with the projection of the “store” information. This graphical depiction aids in the analysis of the query operation, allowing for a clear understanding of the data flow and the underlying database interactions. The data querying instructions may also be used to construct data generating paths described below. More simply, FIG. 1 depicts the above SQL statement for retrieving the “store” field from the “Purchase” dataset, but only for the purchases made by customers (“Customer”) whose identity “id” matches between the “Purchase” dataset and “Customer” datasets, and where the customer's city (“city”) is “Toronto”. Note that the implicit join operation “Purchase P, Customer C”, conditional on “P.id=C.Id” is represented as node 150.

While FIG. 1 illustrates the representation of a data querying instruction as a knowledge graph, knowledge graphs for other types data objects such as data generating paths can be generated analogously.

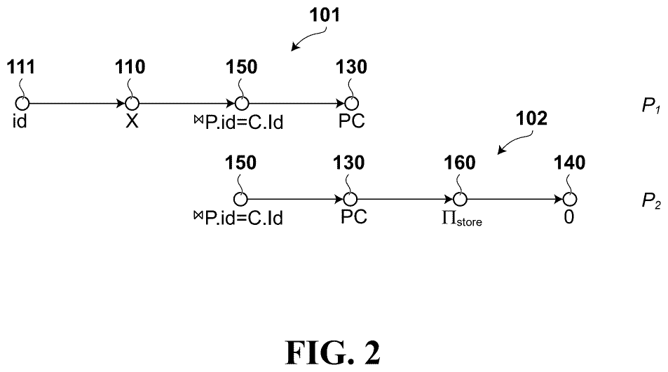

FIG. 2 illustrates two data generating paths 101, 102 (indicated by “P₁” and “P₂” to the right, respectively) used to construct the knowledge graph 100 as shown in FIG. 1. The data generating paths 101, 102 illustrate the sequential operations that lead to the creation of specific data elements within the database. These paths represent the flow of data from its original state through various transformations until it reaches its final form.

The path 101 traces the operations leading to the intermediate data element PC (the primary node 130). It begins with the data element “id” (the starting node 111, may be a single element or a column of elements) for the “Purchase” node 110. Following the direction of the arrows, the path 101 proceeds through the “Purchase” node 110. The subsequent operation, a joint denoted by the node 150 “ [symbol] .id=C.Id”, filters rows of data based on a criterion that the “id” node 111 under the “Purchase” node 110 is equal to the “Id” node 121 under the “Customer” node 120 (P.id=C.Id). This operation results in the generation of the intermediate data element PC comprising data filtered under the criteria of “id”.

Similarly, the path 102 outlines the steps from the selection operation 150 to the final output data element “O” (the primary node 140). This path 102 extends through the data element PC, progressing through the projection operation 160 symbolized by “Πstore”. This operation filters the set of attributes to include only the “store” attribute, ultimately yielding the final output “O”, which is the data element of interest as indicated by the primary node 140 on the right end of the path 102.

Both the paths 101 and 102 illustrate the transformation and flow of data elements as well as the sequence of operations applied to the data. These paths not only depict the lineage of data elements but also highlight the relational algebra operations that transform and refine the data. Such a detailed representation is for understanding the mechanics of data generation within the system and provides a visualization for optimizing database queries and data processing workflows.

Continuing from the illustration of data generating paths in FIG. 2, the knowledge graph framework accommodates the conversion between directed and undirected graphs. This capability ensures the versatility and applicability of various graph algorithms that may be specific to either type of graph.

When dealing with an undirected graph G, a directed graph G′ can be inferred through a process of assigning direction to the edges. If an undirected edge e connects two nodes v₁ and v₂, this edge can be interpreted as a directed edge from v₁ to v₂ or vice versa, depending on the desired directionality for the data flow or operation within the knowledge graph. This conversion allows the use of directed graph algorithms by providing them with the directional context. As an example, the knowledge graph 100 is a directed graph showing the flow of data for retrieving data elements. Accordingly, a knowledge graph having the same nodes but directed edges opposite to those depicted in knowledge graph 100 can show the flow of data for returning data element(s) to a particular location (e.g. data field) in datasets while a knowledge graph having the same nodes but where all edges are undirected can show both the retrieval and return of data elements.

In the reverse scenario, a directed graph T can be transformed into its underlying undirected graph U. This underlying graph U maintains the same nodes as T but disregards the directionality of the edges. An edge {v₁, v₂} exists in U if there is a directed edge from v₁ to v₂, from v₂ to v₁, or both in the original directed graph T. Furthermore, the symmetric part of T, which can be visualized within the same framework, includes nodes where v₁ and v₂ are adjacent if there is a bidirectional relationship, meaning both directed edges (v₁, v₂) and (v₂, v₁) exist in T.

The ability to convert between directed and undirected graphs within the knowledge graph architecture can increase the flexibility of the system. It allows for the integration of a wide range of graph algorithms that can be selectively applied to different aspects of the data management and processing workflows as represented in the knowledge graph. However, the conversion process between directed and undirected graphs within the knowledge graph, as described above, is optional within the system. It is provided as an additional feature to extend the utility and flexibility of the knowledge graph by allowing the application of a wider range of graph algorithms that may be limited to one or the other graph type. This option ensures that the system can be tailored to specific analytical needs and can be implemented or omitted based on the particular requirements of the data management scenario at hand.

In one embodiment, an example of the data querying instructions are SQL statements, the operations of which enable the manipulation, retrieval, and management of data within relational databases. These operations allow users to interact with and modify the data in a structured manner. The effectiveness of these operations affects the integrity, performance, and accessibility of the data stored in database systems. They define how data is structured, related, and ultimately presented to the end user.

In summary, the knowledge graph according to the embodiments described herein may be constructed using relationships among data elements in the data objects. Such relationships delineate a network of interactions and dependencies across the database, optionally including the directionality of the links. These links, represented as edges in the knowledge graph, connect nodes representing different data elements, thereby mapping the relational architecture of the database.

In the described embodiments, the system's inputs, encompassing at least one of data querying instructions or data generating paths, may undergo an additional preprocessing phase to enhance their integration and analysis, corresponding to 722. This phase may begin with “cleaning” to eliminate inaccuracies, redundancies, or irrelevant data, ensuring the inputs accurately reflect the database operations. Subsequently, “normalizing” may be used to adjust the data to a uniform scale or format, addressing the diversity of sources and formats, while “standardizing” aligns the inputs with the system's conventions, promoting consistency. These processes streamline the data from the database, making the format of the input easier to process and ensuring precise evaluation and optimization of the data management practices. It should be understood that depending on specific requirements or contexts, only one or two of these preprocessing processes may be utilized, or in certain instances, none of the processes may be necessary, allowing for flexibility in the system's application and data handling approach.

It should be appreciated that the construction of the knowledge graph within the system is designed with a high degree of flexibility. The knowledge graph may be constructed using data querying instructions, such as SQL statements, data generating paths, or a combination of both. It should also be appreciated that an additional operation of converting data querying instructions into data generating instructions may be involved.

Some examples of operations comprising at least a portion of one or more data objects being represented as knowledge graphs are shown below.

### SQL Operations

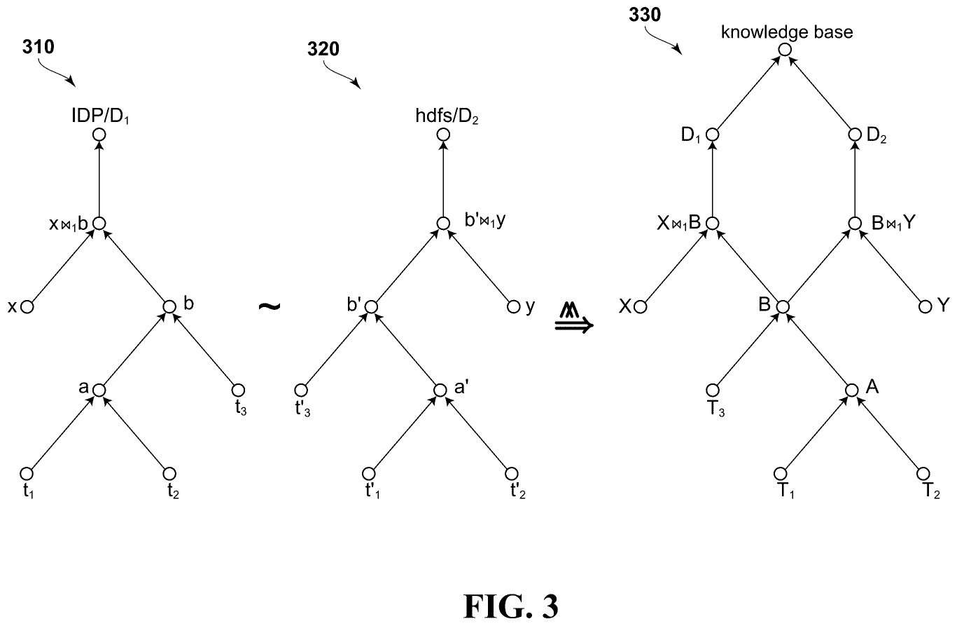

As shown in FIG. 3, SQL operations involve a merge operation according to some embodiments. FIG. 3 illustrates a conceptual process of merging two distinct SQL statements 310 (indicated by S₁) and 320 (indicated by S₂), which correspond to the data tables D₁ and D₂ from Intelligent Data Platform (IDP) and Hadoop Distributed File System (HDFS) storage systems, respectively. The merge operation, denoted as S₁ [symbol] S₂, is the process by which these two statements are unified into a singular, coherent SQL statement, accounting for any overlap in data.

The merge operation begins by identifying any aligned or overlapping components between S₁ and S₂. In FIG. 3, these overlaps are represented by subgraphs topped by b or b′. If S₁ and S₂ are entirely unrelated, with no overlapping data, the merge results in their disjoint union. However, if overlaps exist, as is the case in the example shown in FIG. 3, S₁ [symbol] S₂ is defined to identify and integrate these overlaps into a new, cohesive SQL statement. This newly formed statement retains distinct elements where appropriate while merging the common elements.

For example, within a knowledge base 330 on the right side of FIG. 3, it is shown how the elements of D₁ and D₂ from the original tables are merged. The nodes a, a′, b, and b′ illustrate the data attributes within each table that are to be merged. The nodes labeled from t₁ to t₃ and t₁′ to t₃′ represent the transactional data or tuples within each table. Through the merge operation, these nodes converge into a single branch including nodes T₁, T₂, T₃, A, and B within the knowledge base 330, indicating a unified attribute stemming from the overlap of nodes in the SQL statements 310 and 320.

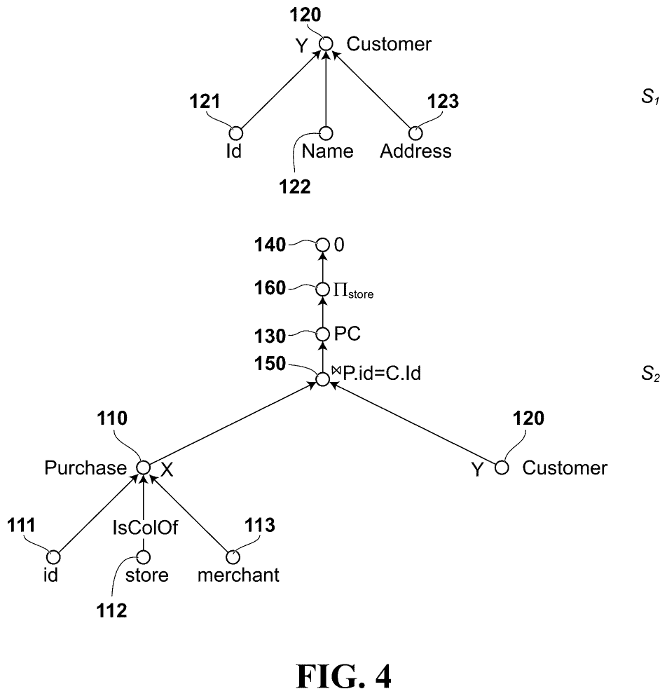

As shown in FIG. 4, the composition of SQL statements provides a systematic approach for constructing complex queries of FIG. 1 by sequencing simpler queries. This compositional operation is denoted as S₂∘S₁, indicating that the output of SQL statement S₁ is supplied as the input to SQL statement S₂. Such an operation can be advantageous in situations where complex data relationships and dependencies require multiple layers of queries to extract meaningful insights. This ability to chain SQL statements through composition extends the capabilities of the query, allowing for more nuanced data retrieval.

In this example, the statement S₁ contains the “Customer” node 120, the “Id” node 121, the “Name” node 122, and the “Address” node 123, with the latter three nodes pointing to the “Customer” node 120. The statement S₂ contains the “Purchase” node 110, the “id” node 111, the “store” node 112, and the “merchant” node 113, with the latter three nodes pointing to the “Purchase” node 110. The “Purchase” node 110 and the “Customer” node 120 then proceeds to the selection operation 150, the intermediate primary node 130, the projection operation 160, and the additional primary node 140. Therefore, with the compositional operation, the statements S₁ and S₂ results in the statements as shown in FIG. 1.

### Data Generating Path Operations

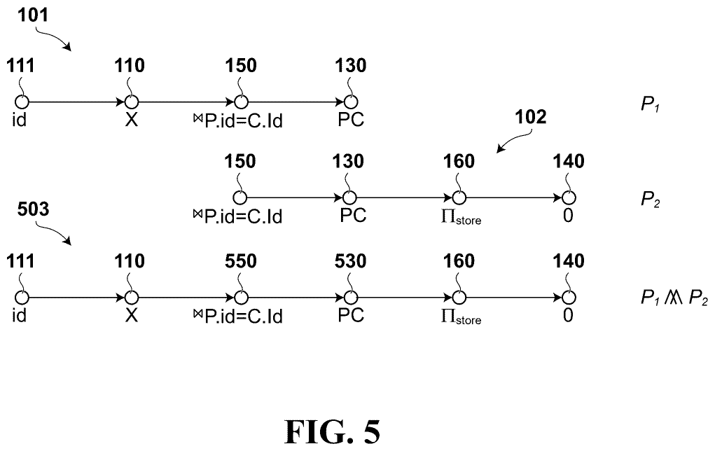

FIG. 5 illustrates a merge operation of multiple data generating paths according to some embodiments described herein. In this example, two distinct data generating paths, P₁ and P₂, are merged to form a unified path.

The paths 101 (indicated by P₁) and 102 (indicated by P₂) are the same paths as shown in FIG. 2. The merge operation, P₁ [symbol] P₂ shows the synthesis of these paths. When P₁ and P₂ are completely unrelated, the merge results in their disjoint union. However, when P₁ and P₂ share common operations or data elements, as indicated by the overlapping nodes and edges in FIG. 5, the merge operation seeks to identify and consolidate these commonalities. The result is a new data generating path 503 that incorporates the shared aspects of both P₁ and P₂ (nodes 550 and 530 in FIG. 5) while maintaining the unique elements of each path where no overlap occurs. The merged path identifies redundancy, optimizes data processing workflows, and ensures that more efficient path is utilized.

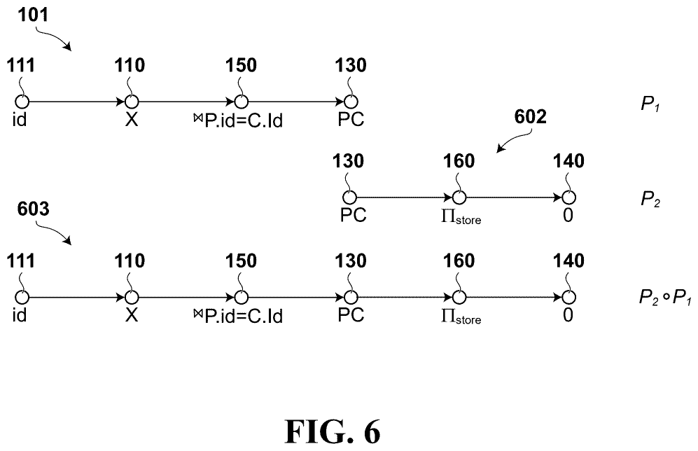

FIG. 6 illustrates a composition operation of multiple data generating paths according to some embodiments described herein. The composition operation, denoted as P₂∘P₁, describes the process whereby the output of one data generating path P₁ becomes the input for another path P₂. This operation helps create complex data transformations.

In FIG. 6, path 101 (indicated by P₁) ending with the node “PC” is the same as the one in FIGS. 2 and 5, while path 602 (indicated by P₂) starts with the node “PC”. As a result, the composition P₂∘P₁ represented in FIG. 6 converts these paths into a single, cohesive sequence of data elements, or a composite path 603 as shown.

### Embedding

Referring again to FIG. 7B, the data objects can be mapped into a low dimensional mathematical space at 728. In particular, at 728, each the data objects or the knowledge graphs corresponding thereto can be mapped (e.g. embedded) into a corresponding vector in vector space. This mapping process can be performed by an embedding or mapping algorithm or machine learning model (e.g. an autoencoder or graph neural network).

In one embodiment, embedding SQL statements and data generating paths into a mathematical framework may facilitate a structured analysis of database operations. This embedding translates the relational operations defined by SQL statements and the sequences of a data generating path into a low dimensional vector space. By doing so, each operation or path can be represented as a vector, allowing for the application of mathematical and algebraic operations to analyze and optimize database queries. The embedding is particularly advantageous for a large graph, meaning for example that the graph contains more than a billion nodes.

For SQL embedding, each SQL statement is not only converted into a node or edge within a knowledge graph but may be further mapped onto a vector within this lower-dimensional space. This mapping preserves algebraic properties such as the following:
Associativity: This property ensures that when three or more SQL statements S₁, S₂, and S₃ are composed in succession, the order in which the compositions take place does not affect the final outcome. Mathematically, this is denoted as (S₁∘S₂)∘S₃=S₁∘(S₂∘S₃), where “∘” represents the composition operation. The preservation of associativity in the vector space means that the resulting vector from the composition of any two SQL statements can be composed with a third, and the final vector will be the same regardless of the composition's grouping or order of operation.
Idempotence: This property ensures that composing an SQL statement with itself will yield the same statement. Represented as S∘S=S, it reflects the fact that the idempotent operation, once represented in the vector space, does not change the vector's direction or magnitude. This ensures that repeated applications of the same operation do not alter the intended result.

Similarly, data generating path embedding takes the sequences of operations from the knowledge graph and embeds them into the vector space while maintaining analogous algebraic constraints:
Associativity: Similar to SQL statement composition, the associativity of data generating paths (P₁∘P₂)∘P₃=P₁∘(P₂∘P₃) is preserved. This ensures that the sequence of data transformations can be grouped or performed in any order without affecting the final data state represented by the resultant vector.

Idempotence: When a data generating path is composed with itself, the result is equivalent to the path on its own, denoted by P∘P=P. In a vector space, this means that if a transformation path is applied repeatedly, the endpoint remains unchanged.

While the transformation of SQL operations and data generating paths into vector representations (e.g. embedding) is optional within the system, it offers a tool for applying linear algebra and vector calculus when optimizing and analyzing database operations. This mathematical abstraction may be particularly useful for databases with more than one billion nodes, where it enables the use of advanced computational techniques in a lower-dimensional mathematical space.

### Matching

At 730, the data objects can be compared to determine similarities between them. In particular, graph matching can be performed on the generated knowledge graphs to determine the similarities. The identified similarities can be set of common elements/operations (e.g. nodes) and/or relationships (e.g. edges) in the knowledge graphs. The received metadata and log files can also provide contextual information (as described above) that can be used for the determination of the similarities. The matching process can be implemented using exact matching such as following the graph isomorphism problem, or using inexact matching (e.g. when exact matching is not possible or where an exact match does not exist) that finds the best possible match. The matching process can be performed in the lower dimensional mathematical space (e.g. vector space) using the knowledge graph embeddings (e.g. vectors). It should be noted that matching algorithms or machine learning models (e.g. multi-layer perception models) can be used to perform the embeddings matching to determine the similarities.

In one embodiment, graph matching may facilitate the analysis of data structures represented within knowledge graphs. It involves the identification of correspondences between graphs, facilitating the detection of structural similarities. This matching can be exact, addressing the graph isomorphism problem, where a one-to-one correspondence between all nodes and edges in two graphs is sought. Alternatively, inexact matching can be pursued, which aims to identify the closest analogous structures between graphs, permitting some differences due to variations or noise in the data.

To compute graph matching and assess similarity effectively, especially in expansive databases, the system may utilize low-dimensional vector spaces derived from graph embedding, if involved. This transforms complex high-dimensional graph data into a more manageable form, where each graph may be represented as a point in a vector space. The embedding process preserves the topological and relational characteristics of the graphs, ensuring that the essential features that define graph similarity are maintained.

To compute graph matching and assess similarity, particularly in large-scale databases, the system conducts matching in a mathematical space to determine similarities between multiple knowledge graphs. If embedding is involved, this process can be further refined by leveraging low-dimensional vector spaces derived from the graph embedding.

With the matching, the system gains insights into the structural, operational, and elemental parallels between different data objects. Understanding the similarities among data elements allows for the adjustment or calibration of cost functions, which are to be explained below, to ensure they accurately reflect the structural, operational, and elemental relationships within the data objects. For example, if two data objects are found to have similar structures but vastly different structural costs, the structural cost function (as described further herein) can be adjusted to account for this discrepancy.

### Ranking by Cost Score

Atal 732, one or more cost functions can be generated. The cost functions can be used to determine a cost or cost score for each of the data objects. The cost score may be a numerical evaluation of the data function based on a number of criteria such as time efficiency, computation efficiency (e.g. resource cost in retrieval/generation), security, etc. The cost functions can be generated based on the received data objects. Alternatively, the cost functions may be pre-generated. At 734, the cost functions can be used to determine a cost score for each of the data objects.

In one embodiment, the method for evaluating and comparing data objects within a database framework involves computing costs associated with different aspects of the knowledge graph. This involves a set, denoted D, of data objects (e.g. the received data querying instructions or data generation paths). To facilitate this evaluation, a number of cost functions may be employed, each of which quantifies different aspects of the knowledge graph, thereby enabling a thorough evaluation of the data objects. The cost functions can be generated in a number of ways. For example, machine learning models may generate the cost functions using training data comprising meta data, historical data (e.g. log data) and the data structure of the data objects such as relationships of data elements (e.g. nodes and edges of the data knowledge graphs). The cost functions can also be built or trained directly using the training data.

For example, each cost function in this set D may be designed to map a data object to a positive real number, effectively assigning a cost that reflects the object's characteristics and its impact on the knowledge graph. This mapping is not arbitrary; it is constructed to preserve the inherent algebraic relationships between data objects. In this way, the cost functions ensure that the assigned costs are not only indicative of the attributes of the data objects, but also maintain the logical consistency required for comparison and analysis.

The cost functions designed to quantify various aspects of data objects within the knowledge graph encompass a data knowledge structure cost, a data operation cost, and a data element cost, each targeting different attributes and characteristics of the data objects:
(a) Data Knowledge Structure Cost (Function S:D→R⁺): The cost associated with the knowledge structure of two data objects, represented as D₁ and D₂ (for example, SQL queries or data generating paths), is evaluated based on their ability to merge and assimilate information (e.g. similarity). This evaluation hinges on the identification and integration of overlapping data elements, aiming to enhance the comprehensiveness of the information. In particular, the similarities determined at 730 may be used to determine the data knowledge structure cost. The concept of a natural partial order, denoted as D₁≤D₂, is defined in this context. It posits that if the merger of D₁ into D₂ (expressed as D₁ [symbol] D₂) does not introduce additional information beyond what is already present in D₂, then D₁ is considered to be less than or equal to D₂ in terms of knowledge structure (e.g. D₂ retrieves or generates as much or more data (elements) than D₁). Note that the partial order may be directly determined from the similarities for use in the data knowledge structure cost or determined as a part of the data knowledge structure cost. The cost function S, mapping data objects to positive real numbers (R⁺), is formulated to respect this partial order, ensuring that the costs reflect the hierarchical relationships based on information content.
(b) Data Operation Cost (Function O:D→R⁺): Recognizing that data elements can be manipulated through various relational algebraic operations, the data operation cost function O is established to quantify the complexity of these operations. Whether it involves prioritizing a join operation before a selection, or vice versa, each sequence of operations embedded within SQL statements or data generating paths incurs a distinct cost. By analyzing the SQL operations and the data elements involved in the query plan tree (e.g. knowledge graph), the function O assigns a cost that encapsulates the operational efficiency (e.g. time/resource cost), contributing to an evaluation of the performance of the data object.
(c) Data Element Cost (Function E:D→R⁺): The intrinsic value and significance of individual data elements may be captured through the data element cost function E. This function acknowledges that data elements are not uniform in their importance or the security standards they adhere to. For example, data elements can be retrieved from more or less secured repositories. Further, the data elements can also be subject to additional routing, augmentation, processing, and modifications that can either enhance or degrade the data security of the data elements. By assigning a cost from the set of positive real numbers (R⁺) to each data element within the set D, the function E facilitates an evaluation that reflects the significance of the data elements.

Leveraging one of the specified cost functions, the system is equipped to generate a cost score, C, which serves as a metric for assessing the performance of a specific aspect of a data object. In scenarios where an integrated evaluation is desired, incorporating all three cost dimensions (structure, operation, and element), the composite cost score may be formulated as C=w₁S+w₂O+w₃E. Here, the weights w₁, w₂, and w₃ may be determined based on empirical data derived from a training set or learned from users' inputs or knowledge bases or graphs, ensuring that each aspect is appropriately weighted according to its impact on overall performance. The data knowledge structure cost, data operation cost, and data element cost can be balanced using the weights according to different objectives. For example, an evaluation with an emphasis on efficiency may assign a greater importance to the data knowledge structure cost using w₁ while an emphasis on security may result in an evaluation with a greater importance on the data element cost using w₃.

Additionally, machine learning may be utilized to supplement the cost functions. Factors, values and criteria considered by the cost functions may be determined using machine learning models. For example, a machine learning model may analyze the data structures to determine relationships between data elements (e.g. nodes) and to analyze the security standards of the data objects. Note that each of the cost functions need not be fixed and may depend on, for example, the use case or the data object being processed. As an example, a first type of data object may be assessed using a first set of cost functions while a second set of cost functions can be assessed using a second set of cost functions. Further, sets of cost functions may be pre-generated and as such can be chosen, modified, or used, based on use case and the data objects to be assessed.

Alternatively, should the analysis focus on combining only two cost functions, such as operational and elemental costs, the cost score may be formulated as C=v₁O+v₂E. Similar to the three-dimensional model, weights v₁ and v₂ may be determined based on empirical data derived from a training set or learned from users' inputs or knowledge bases or graphs, allowing for a tailored assessment that aligns with specific analytical objectives. For example, in the case where data knowledge graph may be partial (e.g. where the generation of a full data knowledge graph is not possible), the total cost can be approximated by both data operation cost and data element cost if the total cost preserves the partial order (e.g. based on the known portions of the knowledge graph or an estimation of the full knowledge graph).

In addition, these cost scores C may be designed to uphold the partial order≤, facilitating a coherent comparison across various data objects, particularly for cases with only operational and elemental costs. This ensures that the evaluation maintains logical consistency, enabling a clear hierarchical ranking of data objects based on their computed cost scores. A higher score may indicate less desirable (e.g. lower) efficiency/security, or vice versa, depending on the formulation of the cost functions. Then, the output of the system may include an intricate knowledge graph accompanied by a semilattice structure that facilitates comparisons, as well as a hierarchical ranking of data querying instructions and data generating paths.

In particular, the cost scores and the partial orders can be used to compare the data objects at 736. That is, the data objects can be compared according to their overall cost C as well as individual cost dimensions (structure, operation, and element). This can be used to determine how efficient/secure a data object is. At 738, the data objects may be ranked, for example according to the comparison at 736. The data objects may be ranked according to the corresponding cost scores, for example to determine the most efficient/secure data object of the received data objects or order the data objects based on their efficiency/security.

After the data objects are ranked, the system may apply the rankings to optimize data processing workflows within the data management system. This phase leverages the hierarchical ordering of data objects to make informed decisions about selecting more efficient and effective strategies for specific data processing tasks.

The optimization process may involve analysis of the ranked data objects, with a particular focus on identifying those associated with lower computational costs regardless of regardless of whether those lower computational costs are expressed as relatively high or relatively low cost scores. By prioritizing data querying instructions or data generating paths that have been ranked highly, the system can adopt optimal paths for data retrieval, manipulation, and analysis. This selection process may also be based on the impact on data management system performance, including factors such as query accuracy, data integrity, and system scalability.

In some embodiments, generated results such as the cost scores, partial orders, and/or the rankings may be validated at 740, for example to ensure that the results are accurate and reasonable (e.g. no abnormal values/results) and not results of errors. If it is determined at 740 that the generated results are abnormal or inaccurate, the data object processing may be repeated, for example starting at 722 again. Otherwise, the generated results can be returned at 742, for example to a user. The returned results can comprise the knowledge graphs, the cost scores and the (ordered) rankings of the data objects or semilattice thereof, for example in a report format.

In some embodiments, a data object may be executed based on the cost scores. For example, the highest ranked (e.g. most efficient/secure) data object may be executed to retrieve/generate the data element specified by the data object. In particular, a plurality of data objects for retrieving/generating the same or similar data element(s) may be received at 720. Accordingly, by comparing and ranking the data objects, the highest ranked (e.g. most efficient/secure) data object can be executed to return the data element(s), which enhances computational efficiency and reduces the time/resource costs associated with the retrieval/generation. In some embodiments, the data objects received at 720 may be retrieved from one or more data lakes or extracted from (e.g. forming a part of) existing platforms/services. If the data objects are for retrieving/generating the same or similar data element(s), the highest ranked data object may replace the other received data object(s). For example, services 1, 2, and 3 respectively use data objects 1, 2, and 3 to generate data element A. At 738, data object 1 was determined as most efficient/secure (e.g. highest ranked). Accordingly, the data object processing method can further comprise replacing data objects 2 and 3 for services 2 and 4 with data object 1, thus enhancing computational efficiency and reducing the time/resource costs associated with the data generation.

FIG. 7A illustrates a flow chart 700 with respect to processing and analyzing data objects which include at least one data querying instructions or data generating paths within a data management system. The initial phase, represented as block 701, involves the retrieval of data objects from a database. This collection of data forms the raw input for the subsequent analysis and optimization processes.

At block 702, which is an optional phase represented by dashed lines, the input data may undergo a preprocessing phase. During this phase, the raw data may be subjected to cleaning, which purges any erroneous or extraneous information that could skew the analysis. This may be followed by normalization, where the data is brought to a common scale or format, facilitating consistency in the subsequent analytical phases. Standardization may be the final part of this phase, ensuring that the data conforms to the system's predefined formats and conventions, for accurate processing.

Proceeding to block 703, data elements are scanned to detect and delineate their relationships. This involves analyzing how data elements are interconnected within the database, including their dependencies and associations, for constructing a meaningful representation of the database's structure.

The construction of knowledge graphs, as depicted in block 704, is the next phase. Here, the relationships among data elements are translated into a visual and analytical framework, with nodes representing data elements and edges representing the relationships between them. Knowledge graphs provide an intuitive means of visualizing the structure and interconnections within the data, for comprehension and analysis.

Blocks 705 and 706 involve embedding the knowledge graphs into low-dimensional mathematical spaces and matching data elements to ascertain similarities, respectively. Embedding is an optional phase, which simplifies the complex, high-dimensional data into a form that is easier to manipulate and analyze mathematically, while the matching phase identifies structural similarities (or differences) between the knowledge graphs.

With the knowledge graph constructed and matched, the flow then moves to block 707, where cost functions are generated. These cost functions are provided to quantify the structural, operational, or elemental aspects of the data objects, providing a basis for their evaluation.

In block 708, cost scores are generated from the cost functions and then ranked. These cost scores serve as a quantitative measure of each data object's efficiency, complexity, and overall impact on the database system.

Block 709 sees the data objects being compared using the partial orders and cost scores generated in the previous phase. This comparison establishes a hierarchy among the data objects, which is then output by block 710 if the performance is satisfied (for example, if the rank is higher than a threshold-a higher rank indicates a better performance of the corresponding data object). The output includes the final reports and the ranked list of data objects, providing actionable insights for optimizing data processing workflows in the data management system. On the other hand, if the performance is not satisfied, the flow goes back to block 702, forming a validation loop.

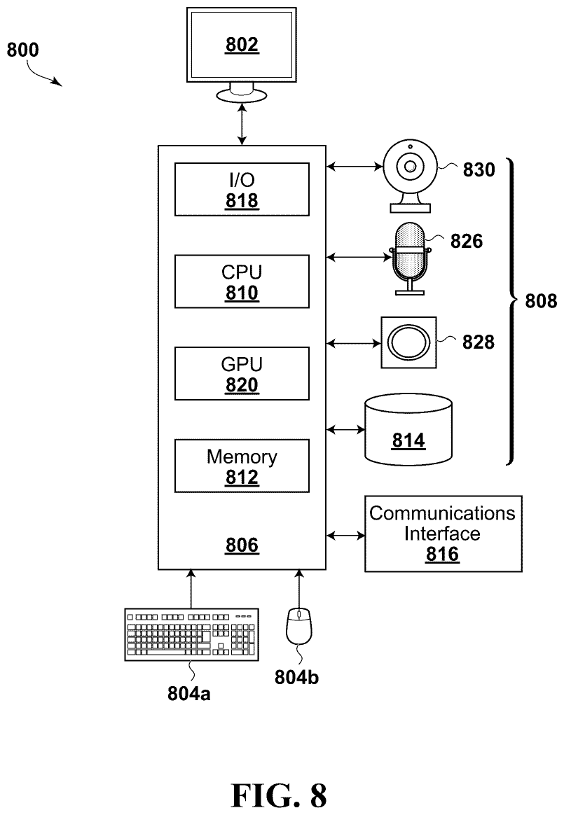

An example computer system in respect of which the one or more of the methods described above may be implemented is presented as a block diagram in FIG. 8. The example computer system is denoted generally by reference numeral 800 and includes a display 802, input devices in the form of keyboard 804a and pointing device 804b, computer 806 and external devices 808. While pointing device 804b is depicted as a mouse, it will be appreciated that other types of pointing device, or a touch screen, may also be used.

The computer 806 may contain one or more processors or microprocessors, such as a central processing unit (CPU) 810. The CPU 810 performs arithmetic calculations and control functions to execute software stored in a non-transitory internal memory 812, preferably random access memory (RAM) and/or read only memory (ROM), and possibly storage 814. The storage 814 is non-transitory may include, for example, mass memory storage, hard disk drives, optical disk drives (including CD and DVD drives), magnetic disk drives, magnetic tape drives (including LTO, DLT, DAT and DCC), flash drives, program cartridges and cartridge interfaces such as those found in video game devices, removable memory chips such as EPROM or PROM, emerging storage media, such as holographic storage, or similar storage media as known in the art. This storage 814 may be physically internal to the computer 806, or external as shown in FIG. 8, or both. The storage 814 may also comprise a database for storing a set of images as described above. For example, the datasets used in the experiments described above may be stored in such a database and retrieved for use in training.

The one or more processors or microprocessors may comprise any suitable processing unit such as an artificial intelligence accelerator, programmable logic controller, a microcontroller (which comprises both a processing unit and a non-transitory computer readable medium), AI accelerator, system-on-a-chip (SoC). As an alternative to an implementation that relies on processor-executed computer program code, a hardware-based implementation may be used. For example, an application-specific integrated circuit (ASIC), field programmable gate array (FPGA), or other suitable type of hardware implementation may be used as an alternative to or to supplement an implementation that relies primarily on a processor executing computer program code stored on a computer medium.

Any one or more of the methods described above may be implemented as computer program code and stored in the internal memory 812 and/or storage 814 for execution by the one or more processors or microprocessors to effect neural network pre-training, training, or use of a trained network for inference.

The computer system 800 may also include other similar means for allowing computer programs or other instructions to be loaded. Such means can include, for example, a communications interface 816 which allows software and data to be transferred between the computer system 800 and external systems and networks. Examples of communications interface 816 can include a modem, a network interface such as an Ethernet card, a wireless communication interface, or a serial or parallel communications port. Software and data transferred via communications interface 816 are in the form of signals which can be electronic, acoustic, electromagnetic, optical or other signals capable of being received by communications interface 816. Multiple interfaces, of course, can be provided on a single computer system 800.

Input and output to and from the computer 806 is administered by the input/output (I/O) interface 818. This I/O interface 818 administers control of the display 802, keyboard 804a, external devices 808 and other such components of the computer system 800. The computer 806 also includes a graphical processing unit (GPU) 820. The latter may also be used for computational purposes as an adjunct to, or instead of, the CPU 810, for mathematical calculations.

The external devices 808 include a microphone 826, a speaker 828 and a camera 830. Although shown as external devices, they may alternatively be built in as part of the hardware of the computer system 800.

The various components of the computer system 800 are coupled to one another either directly or by coupling to suitable buses.

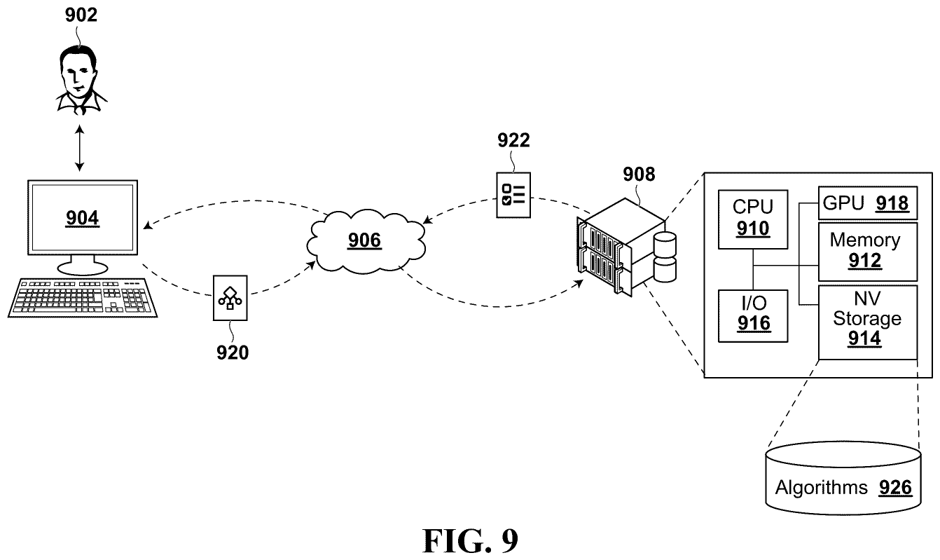

FIG. 9 depicts a system for performing data object processing, according to an example embodiment, shown in FIG. 9 as comprising one or more servers 908. The implementation of the servers 908 is not restrictive and servers 908 may be an on-premises server, cloud-based server, or a hybrid thereof, for example. A user 902 may interact with the servers 908 via a device 904 over a communications network 906 (e.g. the internet). The device 904 may be a computer, as depicted in FIG. 9 and for which an example implementation is described in FIG. 8, but is not restricted to those devices expressly shown and may be any suitable device known in the art such as smart phones and tablets. The servers 908 may provide a graphical user interface (GUI) on the device 904 for case of communication and operation control by the user. The implementation of the GUI is not restrictive and may be, for example, a mobile/computer application or a web page. The GUI can be used to provide input to and receive output from the servers 908. Additionally or alternatively, other user interfaces, such as an audio interface that allows receipt and processing of spoken commands, and that outputs spoken narratives, may be used.

The user 902 may be interested in processing data objects using the servers 908. In particular, the user 902 may be interested in processing a plurality of data objects 920 as to compare and rank the data objects 920 based on a variety of criteria such as efficiency and security. In response, the servers 908 may be configured to retrieve and process the data objects 920 to return an evaluation 922 of the data objects 920. The server 908 can process the data objects by constructing knowledge graphs corresponding to the data objects 920, embedding the data objects 920 in a mathematical space, determining similarities between the data objects 920, and determining a cost score for the data objects 920, as described above in reference to FIGS. 1-8. In particular, the server 908 can process the objects 920 using algorithms or machine learning models 926 to output the evaluation 922 based on the determined cost scores.

According to the present disclosure, the data objects 920 may be transmitted to or retrieved by the servers 908, for example, from the device 904. The servers 908 may comprise or be coupled to one or more databases or data lakes, for example one storing the data objects 920 and/or data elements corresponding to the data objects 920 (e.g. data elements retrievable or generated by the data objects 920). The data objects 920 and the corresponding data elements may be requested, received, or accessed using an application programing interface (API) via requests/calls and responses, for example over the communications network 906, although other forms of communication such as Bluetooth and near-field communication are possible as well. In some embodiments, the algorithms 926 may be stored on a separate server or database coupled to the servers 908. In such embodiments, the servers 908 can interact with the algorithms 926 to process the data objects 920 and to generate the evaluation 922 over the communications network 906, for example using an API.

In a particular implementation, and analogous to the discussion above in respect of FIG. 8, the servers 908 each comprise a central processing unit (“CPU”) 910, a non-transitory computer-readable memory 912, non-volatile storage 914, an input/output interface 916, and a graphical processing unit (“GPU”) 918. The non-transitory computer-readable memory 912 comprises computer-executable instructions stored thereon at runtime which, when executed by the CPU 910, configure the server to perform the herein described data object processing. The non-volatile storage 914 has stored on it computer-executable instructions that are loaded into the non-transitory computer-readable memory 912 at runtime. The input/output interface 916 allows the server to communicate with one or more external devices such as the device 904 (e.g. via network 906). The non-transitory computer-readable memory 912 may also have stored thereon the algorithms 926. The GPU 918 may be used to control a display and may be used to process the data objects 920 to generate the cost scores and the evaluation 922. The servers 908 and the device 904 may each provide a communications interface which allows software and data to be transferred, for example between the servers 908 and the device 904 over the communications network 906.

The CPU 910 and GPU 918 may be one or more processors or microprocessors, which are examples of suitable processing units, which may additionally or alternatively comprise an artificial intelligence accelerator, programmable logic controller, a microcontroller (which comprises both a processing unit and a non-transitory computer readable medium), neural processing unit (NPU), or system-on-a-chip (SoC). As an alternative to an implementation that relies on processor-executed computer program code, a hardware-based implementation may be used. For example, an application-specific integrated circuit (ASIC), field programmable gate array (FPGA), or other suitable type of hardware implementation may be used as an alternative to or to supplement an implementation that relies primarily on a processor executing computer program code stored on a computer medium.

It should be noted that while FIG. 9 depicts the device 904 and the servers 908 as separate entities coupled over the communication network 906, the device 904 and servers 908 may also be coupled directly/physically using cable(s) for data transfer. In some embodiments, the servers 908 may also be the device 904 or comprise the device 904 (e.g. the servers 908 being implemented as a part of a computer system). In such an embodiment, the question 920 can be directly processed by the servers 908.

The term “computer system”, “data processing system” and related terms, as used herein, is not limited to any particular type of computer system and encompasses servers, desktop computers, laptop computers, networked mobile wireless telecommunication computing devices such as smartphones, tablet computers, as well as other types of computer systems.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise. It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections. The term “and/or” as used herein in conjunction with a list means any one or more items from that list. For example, “A, B, and/or C” means A, B, C, A and B, A and C, B and C, or A, B, and C.

Herein, use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The scope of the claims should not be limited by the embodiments set forth in the above examples, but should be given the broadest interpretation consistent with the description as a whole.

It should be recognized that features and aspects of the various examples provided above can be combined into further examples that also fall within the scope of the present disclosure. In addition, the figures are not to scale and may have size and shape exaggerated for illustrative purposes.

It is contemplated that any part of any aspect or embodiment discussed in this specification can be implemented or combined with any part of any other aspect or embodiment discussed in this specification, so long as such those parts are not mutually exclusive with each other.

It would be appreciated by one of ordinary skill in the art that the system and components shown in the figures may include components not shown in the drawings. For simplicity and clarity of the illustration, elements in the figures are not necessarily to scale and are only schematic. It will be apparent to persons skilled in the art that a number of variations and modifications can be made without departing from the scope of the invention as described herein.

While every effort has been made to provide a detailed and accurate description of the disclosure herein, it should be noted that the scope of the disclosure is not limited to the exact configurations and embodiments described. The description provided is intended to illustrate the principles of the disclosure and not to limit the disclosure to the specific embodiments illustrated. It is intended that the scope of the disclosure be defined by the appended claims, their equivalents, and their potential applications in other fields.

1. A data object execution method, comprising:
a) retrieving, from a data lake, input that includes a plurality of data objects;
b) constructing a plurality of knowledge graphs using relationships in the plurality of data objects;
c) matching the plurality of knowledge graphs in a mathematical space to determine similarities among the plurality of knowledge graphs;
d) generating a plurality of cost scores for the plurality of data objects, wherein the cost scores are generated by applying one or more cost functions for evaluating the plurality of data objects, and wherein at least one of the one or more cost functions is determined using the similarities;
e) ranking the at least some of the plurality of data objects based on the plurality of cost scores; and
f) executing at least one of the plurality of data objects based on the ranking.

2. The method of claim 1, wherein the plurality of data objects comprises: one or more data querying instructions, one or more data generating paths, one or more data flow paths, or combinations thereof.

3. The method of claim 2, wherein the one or more data querying instructions comprise Structured Query Language (SQL) statements.

4. The method of claim 1, further comprising: receiving metadata and/or log data associated with the plurality of data objects for the constructing of the knowledge graphs and for determining the similarities.

5. The method of claim 1,
wherein the one or more cost functions comprise a structure cost function that yields data structure costs of the plurality of data objects; and
wherein the data structure costs are determined based on the similarities.

6. The method of claim 1,
wherein the one or more cost functions comprise an operation cost function that yields operation costs of the plurality of data; and
wherein the operation costs correspond to costs of performing operations defined by the plurality of data objects.

7. The method of claim 1,
wherein the one or more cost functions comprise an element cost function that yields data element costs of the plurality of data objects; and
wherein the data element costs are determined based on a significance and/or security standard of the plurality of data objects.

8. The method of claim 4, further comprising:
generating the one or more cost functions based on the meta data, the log data, the plurality of data objects, or combinations thereof.

9. The method of claim 1, wherein the one or more cost functions preserve a partial order of data structures of the plurality of data objects corresponding to amounts of information yielded by the plurality of data objects.

10. The method of claim 1,
wherein each of the plurality of cost scores is calculated as a sum of costs yielded by the one or more cost function;
wherein a weight is assigned to each cost yielded by the one or more cost functions; and
wherein the weight is determined using empirical data derived from a training set, or is learned from users' inputs or the plurality of knowledge graphs.

11. The method of claim 1, further comprising: preprocessing the plurality of data objects, and wherein the preprocessing comprises at least one of cleaning, normalizing, or standardizing.

12. The method of claim 1,
wherein the constructing comprises: translating each of the plurality of data objects into a relational algebra expression;
wherein a node in each of the plurality of knowledge graphs corresponds to a data element or a relational algebraic operations; and
wherein an edge in each of the plurality of knowledge graphs corresponds to a relationship between data elements.

13. The method of claim 1, wherein the matching comprises: embedding the plurality of knowledge graphs into a lower-dimensional vector space.

14. The method of claim 13, wherein the embedding preserves algebraic properties of the plurality of data objects comprising associativity and/or idempotence.

15. The method of claim 1, wherein the similarities are determined using exact matching or best possible matching.

16. The method of claim 1, wherein the plurality of cost scores are represented by positive real numbers.

17. The method of claim 1, further comprising:
validating the plurality of cost scores and
in response to one of the cost scores not satisfying a predetermined condition based on the validating, returning to b).

18. The method of claim 1, further comprising:
applying the ranking to optimize data processing workflows in a data management system, wherein the applying comprises selecting at least one data object for a data processing task based on ranked cost scores.

19. A non-transitory computer readable medium having stored thereon computer instruction that is executable by at least one processor and that, when executed by the at least one processor, causes the at least one processor to perform a data object execution method comprising:
a) retrieving, from a data lake, input that includes a plurality of data objects;
b) constructing a plurality of knowledge graphs using relationships in the plurality of data objects;
c) matching the plurality of knowledge graphs in a mathematical space to determine similarities among the plurality of knowledge graphs;
d) generating a plurality of cost scores for the plurality of data objects, wherein the cost scores are generated by applying one or more cost functions for evaluating the plurality of data objects, and wherein at least one of the one or more cost functions is determined using the similarities;
e) ranking the at least some of the plurality of data objects based on the plurality of cost scores; and
f) executing at least one of the plurality of data objects based on the ranking.

20. A system comprising at least one processor configured to perform a data execution method comprising:
a) retrieving, from a data lake, input that includes a plurality of data objects;
b) constructing a plurality of knowledge graphs using relationships in the plurality of data objects;
c) matching the plurality of knowledge graphs in a mathematical space to determine similarities among the plurality of knowledge graphs;
d) generating a plurality of cost scores for the plurality of data objects, wherein the cost scores are generated by applying one or more cost functions for evaluating the plurality of data objects, and wherein at least one of the one or more cost functions is determined using the similarities;
e) ranking the at least some of the plurality of data objects based on the plurality of cost scores; and
f) executing at least one of the plurality of data objects based on the ranking.
